(19) United States
(12) Patent Application Publication
(10) Pub. No.: US 2021/0099484 A1
(43) Pub. Date: Apr. 1, 2021

(54) PHISHING WEBSITE DETECTION

(71) Applicant: Fortinet, Inc., Sunnyvale, CA (US)

(72) Inventors: Haitao Li, Coquitlam (CA); Lisheng Ryan Sun, Burnaby (CA)

(73) Assignee: Fortinet, Inc., Sunnyvale, CA (US)

(21) Appl. No.: 16/583,707

(22) Filed: Sep. 26, 2019

(51) Int. Cl. H04L 29/06; G06F 16/28; G06F 16/21; G06F 16/22; G06F 16/23; G06F 16/51

(52) U.S. Cl. CPC H04L 63/1483; G06F 16/285; G06F 16/217; G06K 9/6215; G06F 16/2379; H04L 63/1416; G06F 16/51; G06F 16/2255

(57) ABSTRACT

Systems and methods for detection of suspicious phishing webpages are provided. According to one embodiment, a client device captures an image pertaining to a webpage attempted to be accessed via the client device and generates a fingerprint of the webpage based on application of a hash function to the captured image. For each phishing fingerprint within a phishing fingerprint database containing fingerprints associated with known phishing webpages, the client device determines a similarity measure between the generated fingerprint and the phishing fingerprint by comparing the generated fingerprint with the phishing fingerprint such that when the similarity measure meets a threshold, the client device identifies the webpage as potentially being a phishing webpage. The phishing fingerprint database periodically receives an update containing new fingerprints from an online security service.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2019, Fortinet, Inc.

### BACKGROUND

### Field

Embodiments of the present invention generally relate to cybersecurity. In particular, embodiments of the present invention relate to detection of phishing websites.

### Description of the Related Art

The Internet provides an effective medium for not only sharing information but also, unfortunately for spreading malware and/or stealing private account information. With respect to the latter, hackers or fraudsters attempt to trick people into providing private information, e.g., account credentials and/or account numbers, via fake websites they have set up to mimic webpages (e.g., sign-in pages) of online services or companies (e.g., financial institutions (banks, brokerages, PayPal and the like), and e-commerce companies (eBay, Yahoo! And the like)). This practice is sometimes referred to a as “phishing” (because the fraudster is fishing for the private account information of those that visit the fake website, which is sometimes called a “spoofed” site). Many spoofed websites look legitimate and are nearly identical to the websites they are imitating, including logos and other graphics typically associated with the genuine website. A fraudster may lure people to a spoofed website by using a Uniform Resource Locator (URL) that is a commonly mistyped version of a legitimate URL or by sending phishing emails (e.g., “your account password is about to expire, please login and reset it,” “your credit card charge was rejected, please reenter your credit card information”), instant messages and/or voice messages. As a result of the convincing appearance of many spoofed websites, many users believe they are interacting with a legitimate website. At present, 1.5 million new phishing sites are created each month and phishing accounts for 90% of data breaches. As such, phishing is a serious and growing security threat.

An example of a currently available anti-phishing approach relies on a massive blacklist of URLs of known phishing websites to alert end users and/or prevent end users from navigating to phishing websites. Such an approach provides a low false positive rate, but because such a blacklist is typically stored in the cloud due to its size, it is queried by client devices. As such, each URL attempted to be accessed by end users of client devices is sent to the cloud for purposes of performing phishing detection by comparing the URL the end user has requested with URLs contained in the blacklist. As will be appreciated, this approach creates delays as a result of network latency and also represents a privacy issue. So, in effect, this current anti-phishing approach provides phishing detection accuracy at the expense of user privacy.

Recognizing this privacy issue, a few available anti-phishing approaches now attempt to maintain end user privacy by encoding URLs on the client side (e.g., by hashing them) before sending the URLs to the server for phishing detection; however, as those skilled in the art will appreciate, it is a simple matter to decode such hash codes to their original corresponding URLs by using a large database of hash-URL pairs.

### SUMMARY

Systems and methods are described for detection of phishing websites. According to one embodiment, a client device captures an image pertaining to a webpage attempted to be accessed via the client device and generates a fingerprint of the webpage based on application of a hash function to the captured image. For each phishing fingerprint within a phishing fingerprint database containing fingerprints associated with known phishing webpages, the client device determines a similarity measure between the generated fingerprint and the phishing fingerprint by comparing the generated fingerprint with the phishing fingerprint such that when the similarity measure meets a pre-defined or configurable threshold, the client device identifies the webpage as potentially being a phishing webpage. Also, the phishing fingerprint database maintained at the client device is operatively coupled with a server implementing an online security service such that the client device periodically receives an update containing new fingerprints from the online security service.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a network architecture in which aspects of the present invention can be implemented in accordance with an embodiment of the present invention.

FIG. 2A is a block diagram illustrating functional components of a client device in accordance with an embodiment of the present invention.

FIG. 2B is a block diagram illustrating functional components of a server in accordance with an embodiment of the present invention.

FIG. 3 illustrates exemplary interactions among clients and a server in accordance with an embodiment of the present invention.

FIGS. 4A-B are exemplary flow diagrams illustrating client-side processing in accordance with an embodiment of the present invention.

FIGS. 5A-B are exemplary a flow diagrams illustrating server-side processing in accordance with an embodiment of the present invention.

FIG. 6 illustrates an exemplary computer system in which or with which embodiments of the present invention may be utilized.

### DETAILED DESCRIPTION

Systems and methods are described for detection of phishing websites. In one embodiment, using various techniques described herein, detection of phishing websites can be performed almost entirely on the client device and therefore preserves end user privacy in terms of websites visited. According to one embodiment, a fingerprint of a screenshot of webpage is represented in the form of a fixed length bit vector (referred to herein as a “fingerprint”) to allow fast processing. As discussed further below, there are several methods that may be used to generate a fingerprint of an image, such as a screenshot of a webpage. For example, various perceptual hashing or cryptographic hashing can be used. Since the popular targets (usually well-known banks or e-commercial websites) of these phishing URLs are limited, and one target typically corresponds to only several unique screenshots, the use of a perceptual hashing approach generates only a limited number of unique fingerprints corresponding to an ever growing number of phishing URLs (thousands of fingerprints vs. millions of phishing URLs). In addition, use of such a fingerprint can facilitate fast calculation and similarity comparisons. According to one embodiment, only when the client (e.g., a web browser or other client-side application) detects a suspicious phishing URL (e.g., a URL pointing to a webpage having a fingerprint meeting a similarity threshold to a known phishing fingerprint of a database of known (representative) phishing fingerprints provided by an online security service, such as FORTIGUARD security subscription services available from Fortinet, Inc. of Sunnyvale, Calif.), it reports the URL that triggered the detection along with a “vote” to the online security service to inform the service regarding the judgement (opinion) of the end user of the client regarding whether the URL that triggered the local phishing detection is associated with a phishing website or is not associated with a phishing website. In this manner, the security service can essentially crowd source the building of the corpus of known phishing fingerprints based on the reports received from subscribers of the online security service. Meanwhile, clients do not need to submit all of the URLs visited (only those whose fingerprints triggered the local phishing detection) and thus protection of end user privacy is vastly improved.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The term “fingerprint” generally refers to the output of a hash function. In one embodiment, a fingerprint of an image (e.g., a screenshot of a webpage) is the output of a perceptual hash function. Non-limiting examples of perceptual hash functions include aHash, (also referred to as “Average Hash” or “Mean Hash”—a high performance, hardware specific, keyed hash function that encodes an input image into a grayscale 8×8 image and sets the 64 bits in the hash based on whether the pixel's value is greater than the average color for the image), pHash (also referred to as “Perceptive Hash”—an open source perceptual hash library that uses a discrete cosine transform (DCT) and compares based on frequencies rather than color values), and dHash (a Python library that generates a “difference hash” for a given image in the form of a 64-bit “row hash” in which a 1 bit value means the pixel intensity is increasing in the x direction and a 0 bit value means it's decreasing).

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but are not limited to, simple packet forwarding, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

According to one embodiment, a client device captures an image pertaining to a webpage attempted to be accessed via the client device and generates a fingerprint of the webpage based on application of a hash function to the captured image. For each phishing fingerprint within a phishing fingerprint database containing fingerprints associated with known phishing webpages, the client device determines a similarity measure between the generated fingerprint and the phishing fingerprint by comparing the generated fingerprint with the phishing fingerprint such that when the similarity measure meets a pre-defined or configurable threshold, the client device identifies the webpage as potentially being a phishing webpage. Also, the phishing fingerprint database maintained at the client device is operatively coupled with a server implementing an online security service such that the client device periodically receives an update containing new fingerprints associated with known phishing webpages from the online security service.

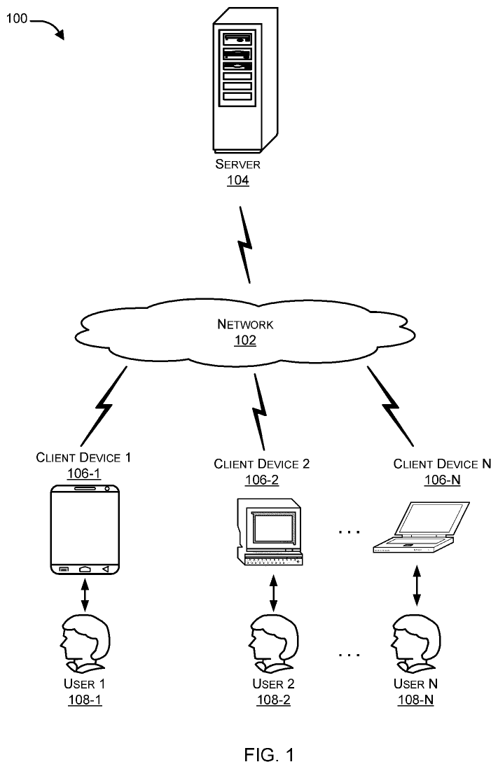

FIG. 1 is a network architecture 100 in which aspects of the present invention can be implemented in accordance with an embodiment of the present invention. In network architecture 100, a security service can be implemented within a security server 104. Further, users 108-1, 108-2 . . . 108-N (which may be collectively referred to as users 108 and individually referred to as user 108, hereinafter) can interact with the security service using their respective client devices 106-1, 106-2 . . . 106-N (which may be collectively referred to as client devices 106 and individually referred to as client device 106, hereinafter) using a network 102. Client devices 106 may include, but are not limited to, personal computers, smart devices, web-enabled devices, hand-held devices, laptops, mobile phones and the like, to enable interaction with network 102.

Those skilled in the art will appreciate that, network 102 can be wireless network, wired network or a combination thereof that can be implemented as one of the different types of networks, such as Intranet, Local Area Network (LAN), Wide Area Network (WAN), Internet, and the like. Further, network 102 can either be dedicated network or a shared network. A shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like. In an implementation, security service can be implemented as a cloud-based service that can be provisioned and accessed through a cloud computing provider, exterior to the network 102 or any suitable network or computing device operatively coupled with network 102.

According to an aspect of the present invention, client device 106 (via an endpoint security solution running thereon, for example) can capture an image or a screenshot pertaining to a webpage, which is attempted to be accessed at client device 106 by user 108. Further, client device 108 apply can apply a hash function, which can include a perceptual hash function e.g. a dHash, to the captured image to generate a fingerprint (of e.g. 128 bits) of the webpage. In an example, the fingerprint can be generated by converting the captured image to a grayscale image and downsizing the grayscale image to a thumbnail image of a pre-determined size such that a row hash and a column hash for the thumbnail image can be determined to form the fingerprint by combining the row hash and the column hash. Alternately, the generated fingerprint can include a combination of a row hash and a column hash of a downsized grayscale version of the captured image.

In an embodiment, client device 106 can maintain a phishing fingerprint database, which can contain fingerprints associated with known phishing webpages (e.g., those confirmed by a crowdsourced approach involving subscribers of an online security service). The local phishing fingerprint database maintained by client device 106 can be an updated by periodically receiving new fingerprints from an online security service. In one embodiment, each phishing fingerprint can be representative of a cluster of multiple fingerprints, thereby improving efficiency of transmission of the update from the online security service to client device 106 and performance of comparing by client device 106. During the comparing, for each phishing fingerprint within the phishing fingerprint database, client device 106 can compare the generated fingerprint with the phishing fingerprint to determine a similarity measure between the generated fingerprint and the phishing fingerprint.

In an example, the similarity measure can include a cumulative similarity index, which can be determined based on a number of corresponding bits that differ between the generated fingerprint and the phishing fingerprint by performing an exclusive or (XOR) operation between the generated fingerprint and each of the fingerprints. In response to the similarity measure meeting a predefined or configurable threshold, client device 106 can identify the webpage as potentially being a phishing webpage.

In an embodiment, when the similarity measure meets the predefined or configurable threshold, client device 106 causes the respective user 108 to be prompted to provide his/her opinion regarding whether the identification of the webpage as a phishing webpage is correct and information regarding the end user's opinion can be reported to the online security service. In this manner, the online security service receives feedback from the subscriber base to improve phishing detection on behalf of the subscriber base.

According to an aspect of the present invention, server 104 implementing the online security service maintains a first database of suspicious webpages that have been reported by client devices 106 of subscribers/users 108 to the online security service. For each suspicious webpage, the first database can include a suspicious fingerprint of the suspicious webpage generated based on application of a hash function to an image of the suspicious webpage, a first count of reports received by client devices 106 identifying the suspicious webpage as a phishing webpage, a second count of reports received by client devices 108 identifying the suspicious webpage as not being a phishing webpage, and a ratio of the first count or the second count to a sum of the first count and the second count.

Server 104 can also maintain a second database of confirmed phishing webpages. For each confirmed phishing webpage, the second database can include a confirmed fingerprint of the confirmed phishing webpage generated based on application of the hash function to an image of the confirmed phishing webpage, an indication regarding a cluster of clusters of fingerprints with which the confirmed fingerprint is associated, and an indication regarding whether the confirmed fingerprint has been selected as the representative of the cluster.

In an implementation, server 104 can periodically update the clusters of fingerprints for each suspicious webpage by comparing the ratio for the suspicious webpage to a predetermined or configurable threshold such that when the comparing is indicative of the suspicious webpage being a confirmed phishing webpage, server 104 performs a clustering process to either add the suspicious fingerprint of the suspicious webpage to an existing cluster of the clusters of fingerprints or create a new cluster within the clusters of fingerprints for which the suspicious fingerprint can serve as a representative of the new cluster. Server 104 also facilitates detection of phishing webpages by client devices 106 by periodically delivering updates to users 108 including at least representative fingerprints of new clusters added to the clusters of fingerprints, if any, since the last update delivery.

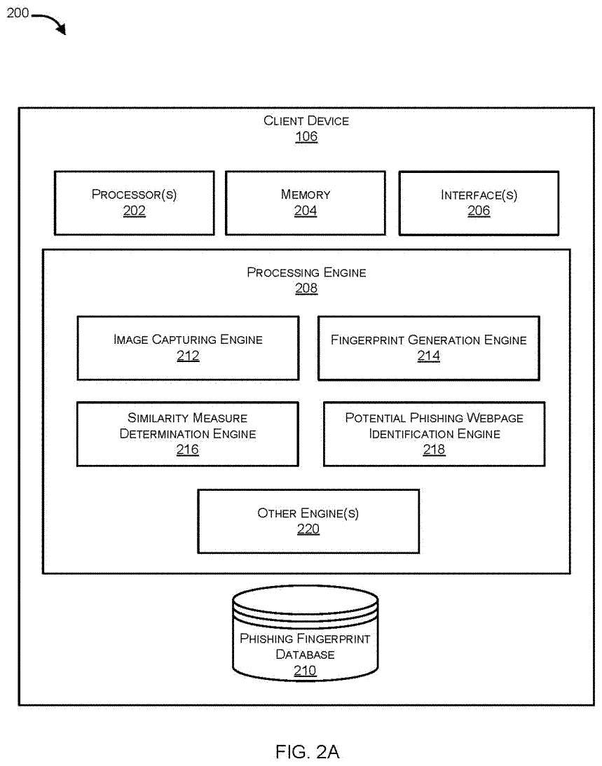

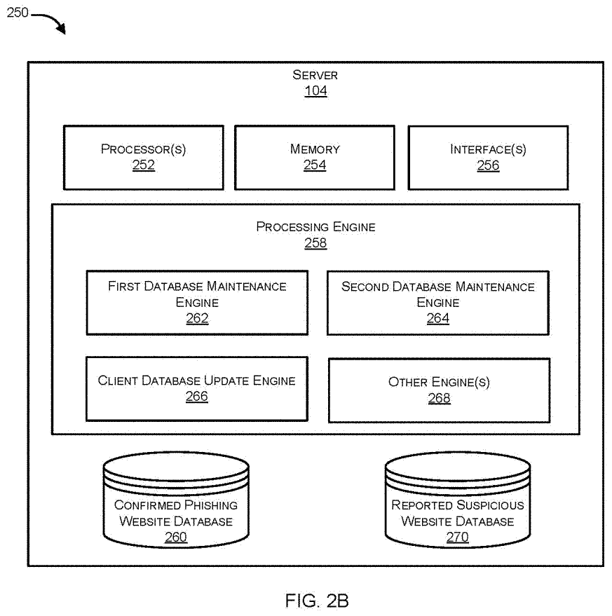

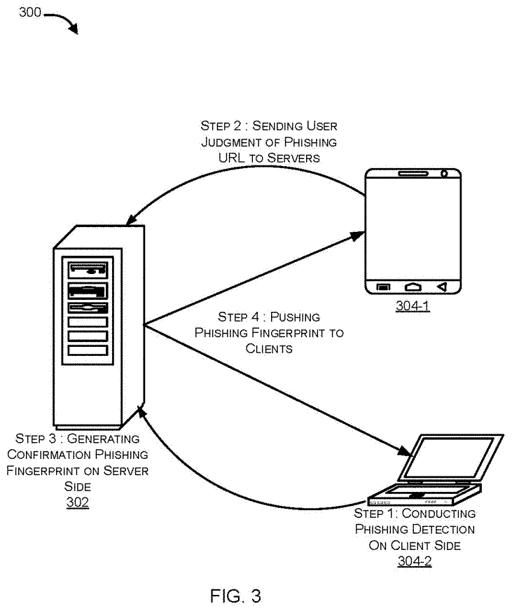

FIG. 2A is a block diagram 200 illustrating functional components of a client device 106 in accordance with an embodiment of the present invention. As illustrated, client device 106 can include one or more processor(s) 202. Processor(s) 202 can be implemented as one or more microprocessors, microcomputers, microcontrollers, digital signal processors, central processing units, logic circuitries, and/or any devices that manipulate data based on operational instructions. Among other capabilities, processor(s) 202 are configured to fetch and execute computer-readable instructions stored in a memory 204 of client device 106. Memory 204 can store one or more computer-readable instructions or routines, which may be fetched and executed to create or share the data units over a network service. Memory 204 can include any non-transitory storage device including, for example, volatile memory such as RAM, or non-volatile memory such as EPROM, flash memory, and the like. In an example embodiment, memory 204 may be a local memory or may be located remotely, such as a server, a file server, a data server, and the Cloud.

Client device 106 can also include one or more Interface(s) 206. Interface(s) 206 may include a variety of interfaces, for example, interfaces for data input and output devices, referred to as I/O devices, storage devices, and the like. Interface(s) 206 may facilitate communication of client device 106 with various devices coupled to client device 106. Interface(s) 206 may also provide a communication pathway for one or more components of client device 106. Examples of such components include, but are not limited to, processing engine(s) 208 and phishing fingerprint database 210.

Processing engine(s) 208 can be implemented as a combination of hardware and software or firmware programming (for example, programmable instructions) to implement one or more functionalities of engine(s) 208. In the examples described herein, such combinations of hardware and software or firmware programming may be implemented in several different ways. For example, the programming for the engine(s) may be processor executable instructions stored on a non-transitory machine-readable storage medium and the hardware for engine(s) 208 may include a processing resource (for example, one or more processors), to execute such instructions. In the examples, the machine-readable storage medium may store instructions that, when executed by the processing resource, implement engine(s) 208. In such examples, client device 106 can include the machine-readable storage medium storing the instructions and the processing resource to execute the instructions, or the machine-readable storage medium may be separate but accessible to client device 106 and the processing resource. In other examples, processing engine(s) 208 may be implemented by electronic circuitry. Phishing Fingerprint database 210 can include data that is either stored or generated as a result of functionalities implemented by any of the components of processing engine(s) 208.

In an example, processing engine(s) 208 can include an image capturing engine 212, a fingerprint generation engine 214, a similarity measure determination engine 216, a potential phishing webpage identification engine 218 and other engine(s) 220. Other engine(s) 220 can implement functionalities that supplement applications or functions performed by client device 106 or processing engine(s) 208.

According to an embodiment image capturing engine 212 captures an image or a screenshot pertaining to a webpage that is attempted to be accessed via client device 106 and provides the captured image to fingerprint generation engine 214.

According to an embodiment, fingerprint generation engine 214 generates a fingerprint (of say 120 bits) of the webpage based on application of a hash function to the captured image. For example, the hash function including a perceptual hash function such as a dHash can be applied to the captured image to generate the fingerprint. In one example, a fingerprint can be generated by converting the captured image to a grayscale image such that the grayscale image can be downsized to a thumbnail image of a pre-determined size. Fingerprint generation engine 214 can then determine a row hash and a column hash for the thumbnail image to form the fingerprint by combining the row hash and the column hash. In another example, the generated fingerprint can include a combination of a row hash and a column hash of a downsized grayscale version of the captured image.

According to an embodiment, phishing fingerprint database 210 is operatively coupled with an online security service and contains fingerprints associated with known phishing webpages. Phishing fingerprint database 210 periodically receives an update containing new fingerprints from the online security service. Those skilled in the art will appreciate that each phishing fingerprint contained within phishing fingerprint database 210 can be representative of a cluster of various fingerprints, which can improve efficiency of transmission of the update from the online security service to client device 106 as well as the efficiency of performing phishing detection (e.g., comparing fingerprints) by potential phishing webpage identification engine 218 of client device 106.

In one embodiment, for each phishing fingerprint within phishing fingerprint database 210, similarity measure determination engine 216 determines a similarity measure between the generated fingerprint and the phishing fingerprint by comparing the generated fingerprint with the phishing fingerprint. The similarity measure can include a cumulative similarity index, which can be determined based on a number of corresponding bits that differ between the generated fingerprint and the phishing fingerprint. In one example, the cumulative similarity index can be determined by performing an exclusive or (XOR) operation between the generated fingerprint and each of the plurality of fingerprints.

When the similarity measure meets a predefined or configurable threshold, potential phishing webpage identification engine 218 identifies the webpage as potentially being a phishing webpage. Further, potential phishing webpage identification engine 218 prompts an end user of client device 106 to provide his/her opinion regarding whether the identification is correct so that information regarding the opinion can be reported to the online security service.

FIG. 2B is a block diagram 250 illustrating functional components of a server 104 in accordance with an embodiment of the present invention. Those skilled in the art will appreciate that similar to client device 106 as described above, server 106 can also be a device including one or more processor(s) 252, memory 254, interface(s) 256 and one or more other components including, but not limited to, processing engine(s) 258, confirmed phishing website database 260 and reported suspicious website database 270.

Processing engine(s) 258 can be implemented as a combination of hardware and software or firmware programming (for example, programmable instructions) to implement one or more functionalities of engine(s) 208 and can include a first database maintenance engine 262, a second database maintenance engine 264, a client database update engine 266 and other engine(s) 268. Other engine(s) 268 can implement functionalities that supplement applications or functions performed by serve 104 or processing engine(s) 258.

According to an embodiment, a first database maintenance engine 262 maintains a first database (i.e., reported suspicious website database 270) that contains suspicious webpages reported by client devices of subscribers/users of online security service. For each suspicious webpage, reported suspicious website database 270 can include a suspicious fingerprint of the suspicious webpage, a first count of reports, a second count of reports and a ratio of the first count or the second count to a sum of the first count and the second count such that the fingerprint is generated based on application of a hash function to an image of the suspicious webpage, the first count of reports received by client devices of the subscribers identifies the suspicious webpage as a phishing webpage and a the second count of reports received by client devices of the subscribers identifies the suspicious webpage as not being a phishing webpage. Therefore, first database maintenance engine 262 tracks the “votes” (i.e., confirmed phishing responses and false responses (not phishing)) by the clients as well as a ratio of the number of false responses to the total number of responses or a ratio of the number of confirmed responses to the total number of responses.

In an embodiment, second database maintenance engine 264 can maintain a second database (i.e., confirmed phishing website database 260) that contains confirmed phishing web sites and maintains information regarding the clusters of fingerprints and the representatives of the clusters. For each confirmed phishing webpage, confirmed phishing web site database 260 can include a confirmed fingerprint of the confirmed phishing webpage generated based on application of the hash function to an image of the confirmed phishing webpage, an indication regarding a cluster of a plurality of clusters of fingerprints with which the confirmed fingerprint is associated, and an indication regarding whether the confirmed fingerprint is a representative of the cluster.

Further, in accordance with one embodiment, there is a periodic (e.g., once per hour, once per day, etc.) clustering process that incorporates those of the suspicious phishing websites reported by client devices of subscribers that meet a predetermined or configurable threshold into the clusters maintained within confirmed phishing website database 260. Second database maintenance engine 264 can periodically update the clusters of fingerprints, by comparing the ratio for each suspicious webpage to a predetermined or configurable threshold such that when the comparing is indicative of the suspicious webpage being a confirmed phishing webpage, then second database maintenance engine 264 can perform a clustering process to either add the suspicious fingerprint of the suspicious webpage to an existing cluster of the clusters of fingerprints or create a new cluster within the clusters of fingerprints for which the suspicious fingerprint can serve as a representative of the new cluster.

Further, in the context of the present example, client database update engine 266 can facilitate detection of phishing webpages by client devices by periodically delivering updates to client devices of the subscribers such that the client devices can update their local databases. The updates can include at least representative fingerprints of new clusters added to the clusters of fingerprints, if any, since the last update.

FIG. 3 illustrates exemplary interactions among clients 304-1 and 304-2 and a server 302 in accordance with an embodiment of the present invention. In the context of example 300, phishing detection is conducted on the client side based on locally generated fingerprints of webpages attempted to be accessed. When a webpage is detected as potentially being a phishing webpage by client devices 304-1 or 304-2 (which are collectively referred to client devices 304 and individually referred to as client device 304, hereinafter), the user may opine on the phishing determination as correct or not (based on his/her judgement of the webpage at issue) and this opinion can be reported to server 302. Server 302 can make a final confirmation of a suspicious phishing webpage by combining multiple votes from different client devices 304, and regularly push the fingerprints of the latest confirmed phishing webpages to client devices 304.

Those skilled in the art will appreciate that several techniques can be used to generate fingerprint of a webpage, such as perceptual hashing or cryptographic hashing. Perceptual hashing is thought to produce better results in the present context since it relies on similarity of features, whereas cryptographic hashing (e.g., MD5) relies on the avalanche effect of a small change in the input value creating a drastic change in the output value. Perceptual hashing can have different implementations, such as aHash, pHash, dHash, etc.

In the context of the present example, at step 1, client device 304 can capture an image or screenshot of a webpage accessed at client device 304 and generate a hash value, for example, a 128-bit hash of the captured image. In an exemplary implementation, to generate the hash value, the captured image can be converted to grayscale (e.g., using an equation Gray=R*0.299+G*0.587+B*0.114). The grayscale image can be downsized into a thumbnail (e.g., a 9×9 thumbnail or other suitable thumbnail depending upon the hash size). Further, the thumbnail can be used to produce a row hash (e.g., a 64-bit row hash), where 1 means the pixel intensity is increasing in the X direction, 0 means the pixel intensity is decreasing in the X direction. Similarly, a column has (e.g., a 64-bit column hash) can be produced in the Y direction. Further, the two hash values can be combined to produce the final hash value (e.g., a 128-bit hash value) as the fingerprint of the webpage. Client device 304 can then compare the generated fingerprint with the fingerprints of phishing web pages maintained in local database of client device 340, and calculate similarity measures with various fingerprints present in the local database. The similarity measure can be defined as the number of bits difference. For example, considering two hash values X and Y, the similarity measure can be defined as Similarity(X, Y)=(X xor Y).count(1). Further, when similarity value meets a threshold, e.g. if the similarity value is smaller than a threshold (e.g., 5), client device 304 may flag the webpage as a potential phishing webpage, display the result to the respective user and seek his/her opinion with regard to whether the user perceives the webpage to be a phishing webpage.

At step 2, the opinion or user's judgment can be sent to server 302 such that server 302 can collect response from various clients 304. For example, opinions about suspicious phishing webpages detected by various clients 304 can be collected from the various clients 304. In one implementation, at step 3, server 302 can confirm a suspicious phishing webpage as a phishing webpage if FR <R, where FR is ratio of false responses (i.e., reports by end users indicating the phishing judgment by the client device is wrong, and the webpage at issue is not a phishing webpage) to total responses (i.e., the total of all end user “votes” including false responses and positive responses), and R is a threshold (e.g., R=0.5). Therefore, if the ratio of false responses to total responses is small, this means a large majority of votes by end users have confirmed the detection of the phishing webpage to be correct.

Further, server 302 can cluster fingerprints of confirmed phishing webpages, by putting similar (e.g., having a similarity score of less than 5) fingerprints together and randomly taking one as the cluster fingerprint, which can significantly reduce the number of phishing fingerprints. Finally, at step 4, server 304 can push the latest cluster fingerprints to client devices 304. While in one embodiment, a simplistic clustering approach is used for sake of efficiency, in alternative embodiments other more complex clustering approaches may be used. Non-limiting examples of alternative clustering approaches include partitioning methods (e.g., K-means clustering), spectral clustering, Density-Based Spatial Clustering of Applications with Noise (DBSCAN) clustering, hierarchical clustering, fuzzy clustering and model-based clustering.

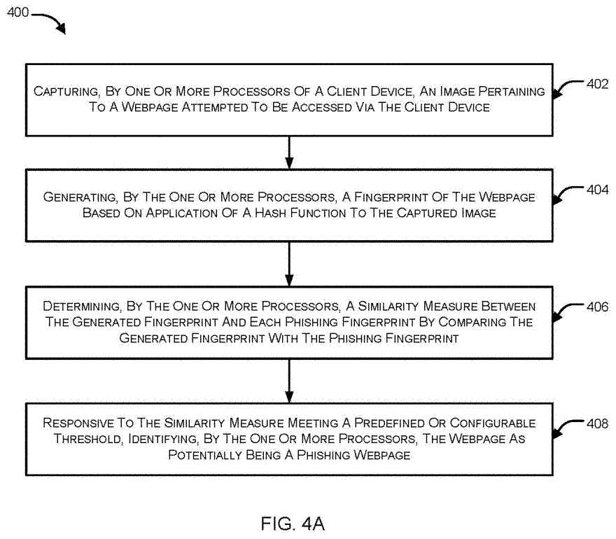

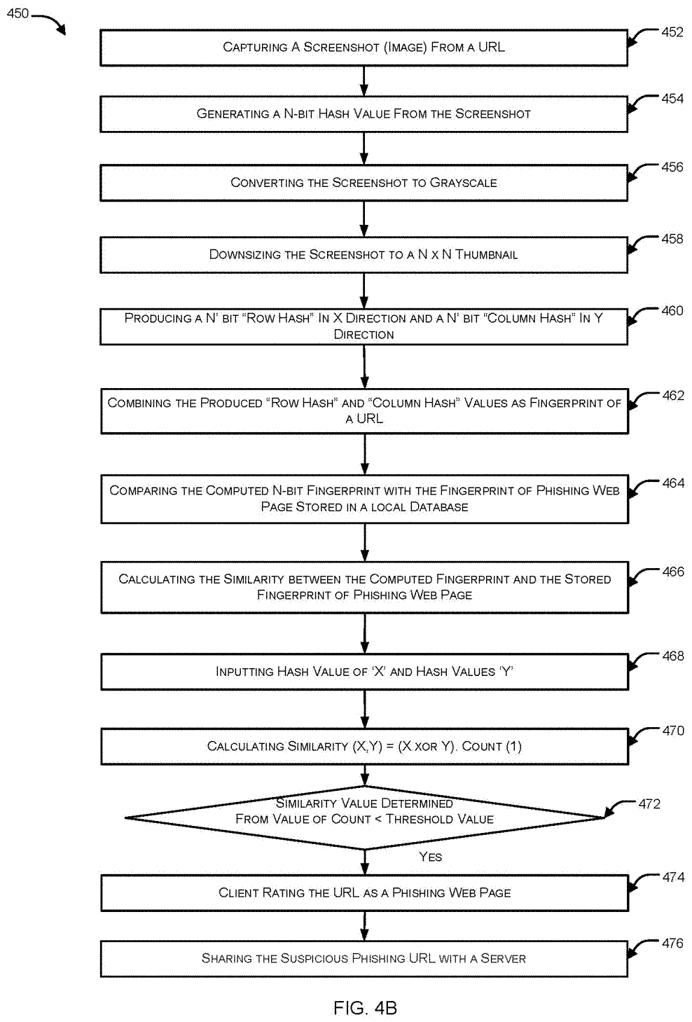

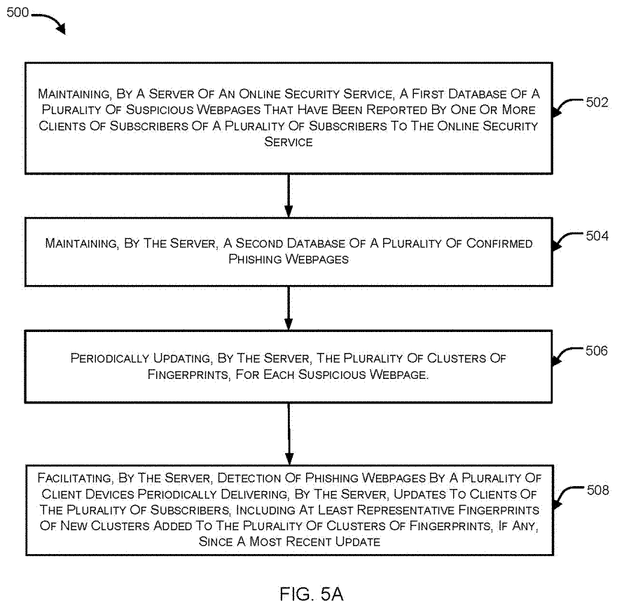

FIGS. 4A-B are exemplary flow diagrams 400 and 450 illustrating client-side processing in accordance with embodiments of the present invention. In the context of flow diagram 400, at block 402, a client device captures an image pertaining to a webpage attempted to be accessed via the client device and at block 404, the client device generates a fingerprint of the webpage based on application of a hash function to the captured image. Further, for each phishing fingerprint within a phishing fingerprint database containing fingerprints associated with known phishing webpages (e.g., including those confirmed by subscribers of the online security service), at block 406 the client device determines a similarity measure between the generated fingerprint and the phishing fingerprints in the local database by comparing the generated fingerprint with the phishing fingerprint such that when the similarity measure meets a predefined or configurable threshold, at block 408, the client device identifies the webpage as potentially being a phishing webpage.

In the context of flow diagram 450, at block 452, a client device captures an image or screenshot of a webpage accessed using a URL at the client device and at block 454, the client device initiates generation of an n-bit hash value, e.g. of 128-bits, from the captured image. As an example, generating the n-bit hash value can be performed by following a process through block 456 to 464. For example, at block 456, the captured image can be converted to grayscale e.g., using an equation Gray=R*0.299+G*0.587+B*0.114 and at block 458, the grayscale image can be downsized into a thumbnail, e.g., a 9×9 thumbnail. At block 460, a w-bit row hash can be produced in the X direction and an q-bit column hash can be produced in the Y direction. Further, at block 462, the two hash values can be combined to produce the final n-bit hash value as the fingerprint of the webpage.

At block 464, the client device can then compare the n-bit fingerprint with the fingerprints of phishing webpages stored in the local database of the client device, and at block 466, the client device can initiate calculation of similarity measures of the generated fingerprint with various fingerprints present in the local database. For example, at block 468, the client device can take the input of two hash values X and Y so that at block 470, the similarity measure can be can be calculated by Similarity(X, Y)=(X xor Y).count(1). At block 472, the similarity measure can be compared with a threshold value such that when the similarity measure is less than a threshold value, e.g., if the similarity value is smaller than a threshold (e.g., 2, 3, or 5 bit differences), at block 474 the client device can allow the client or a user to rate or opine on the phishing determination such that at block 476, the suspicious webpage and opinion can be shared with the server.

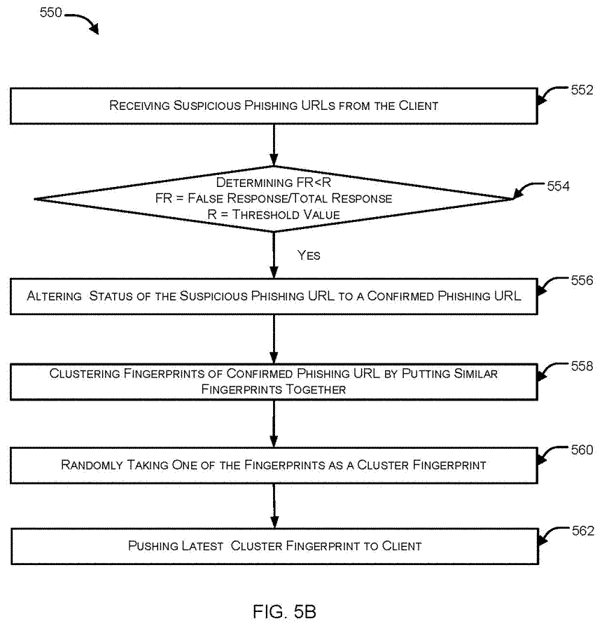

FIGS. 5A-B are exemplary a flow diagrams 500 and 550 illustrating server-side processing in accordance with an embodiment of the present invention. In the context of flow diagram 500, at block 502, a server of an online security service maintains a first database of suspicious webpages that have been reported by client devices of subscribers of the online security service. For each suspicious webpage, the first database can include a suspicious fingerprint of the suspicious webpage generated based on application of a hash function to an image of the suspicious webpage, a first count of reports received by clients of the subscribers identifying the suspicious webpage as a phishing webpage, a second count of reports received by clients of the subscribers identifying the suspicious webpage as not being a phishing webpage, and a ratio of the first count or the second count to a sum of the first count and the second count.

At block 504, the server maintains a second database of confirmed phishing webpages. For each confirmed phishing webpage, the second database can include a confirmed fingerprint of the confirmed phishing webpage generated based on application of the hash function to an image of the confirmed phishing webpage, an indication regarding a cluster of a plurality of clusters of fingerprints with which the confirmed fingerprint is associated, and an indication regarding whether the confirmed fingerprint is a representative of the cluster.

At bock 506, the server periodically updates the clusters of fingerprints for each suspicious webpage by comparing the ratio for the suspicious webpage to a predetermined or configurable threshold and when the comparing is indicative of the suspicious webpage being a confirmed phishing webpage, then performing a clustering process to either add the suspicious fingerprint of the suspicious webpage to an existing cluster of the clusters of fingerprints or create a new cluster within the clusters of fingerprints for which the suspicious fingerprint will serve as a representative of the new cluster.

At block 508, the server facilitates detection of phishing webpages by client devices by periodically delivering updates to the client devices of the subscribers, including at least representative fingerprints of new clusters added to the clusters of fingerprints, if any, since a most recent update.

In the context of flow diagram 550, at block 552, server receives the opinion or user's judgment from the client devices. In one implementation, at block 554, can compare the ratio of false responses (FR) to total responses with a threshold R such that when FR<R, at block 556, the server can confirm a suspicious phishing webpage as a phishing webpage.

Further, at block 558, the server can cluster fingerprints of confirmed phishing webpages, by putting similar fingerprints together and at 560, randomly taking one of the fingerprints as the cluster fingerprint, thereby significantly reducing the number of phishing fingerprints. Finally, at block 562, the server can push the latest cluster fingerprints to various client devices. While in one embodiment, the representative of a cluster is randomly selected for purposes of efficiency of processing, in alternative embodiment other approaches may be used. Non-limiting examples of approaches for selecting a cluster representative include identifying the mean of the cluster members, selecting the “typical” (average) member (e.g., centroid) of the cluster, selecting the “least typical” member, and selecting the “most typical” member.

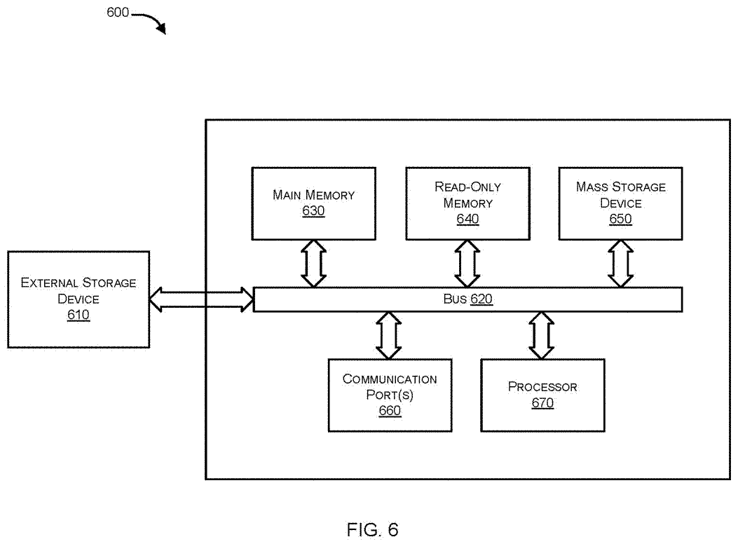

FIG. 6 illustrates an exemplary computer system 600 in which or with which embodiments of the present invention may be utilized. Computer system 600 may represent all or a portion of a client device (e.g., client device 106) or a server device (e.g., server 104). As shown in FIG. 6, computer system includes an external storage device 610, a bus 620, a main memory 630, a read only memory 640, a mass storage device 650, a communication port 660, and a processor 670. Computer system may represent some portion of server 104 or client device 106.

Those skilled in the art will appreciate that computer system 600 may include more than one processor 670 and communication ports 660. Examples of processor 670 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 670 may include various modules associated with embodiments of the present invention.

Communication port 660 can be any of an RS-232 port for use with a modem-based dialup connection, a 10/100 Ethernet port, a Gigabit or 10 Gigabit port using copper or fiber, a serial port, a parallel port, or other existing or future ports. Communication port 660 may be chosen depending on a network, such a Local Area Network (LAN), Wide Area Network (WAN), or any network to which computer system connects.

Memory 630 can be Random Access Memory (RAM), or any other dynamic storage device commonly known in the art. Read only memory 640 can be any static storage device(s) e.g., but not limited to, a Programmable Read Only Memory (PROM) chips for storing static information e.g. start-up or BIOS instructions for processor 670.

Mass storage 650 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 620 communicatively couples processor(s) 670 with the other memory, storage and communication blocks. Bus 620 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 670 to software system.

Optionally, operator and administrative interfaces, e.g. a display, keyboard, and a cursor control device, may also be coupled to bus 620 to support direct operator interaction with computer system. Other operator and administrative interfaces can be provided through network connections connected through communication port 660. External storage device 610 can be any kind of external hard-drives, floppy drives, IOMEGA® Zip Drives, Compact Disc—Read Only Memory (CD-ROM), Compact Disc—Re-Writable (CD-RW), Digital Video Disk-Read Only Memory (DVD-ROM). Components described above are meant only to exemplify various possibilities. In no way should the aforementioned exemplary computer system limit the scope of the present disclosure

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A method of detecting phishing webpages, the method comprising:
capturing, by one or more processors of a client device, an image pertaining to a webpage attempted to be accessed via the client device;
generating, by the one or more processors, a fingerprint of the webpage based on application of a hash function to the captured image;
for each phishing fingerprint within a phishing fingerprint database containing a plurality of fingerprints associated with one or more of a plurality of known phishing webpages:
determining, by the one or more processors, a similarity measure between the generated fingerprint and the phishing fingerprint by comparing the generated fingerprint with the phishing fingerprint; and
responsive to the similarity measure meeting a predefined or configurable threshold, identifying, by the one or more processors, the webpage as potentially being a phishing webpage.

2. The method of claim 1, further comprising periodically receiving, by the one or more processors, an update to the phishing fingerprint database containing new fingerprints from an online security service.

3. The method of claim 2, further comprising responsive to the similarity measure meeting the predefined or configurable threshold:
causing, by the one or more processors, an end user of the client device to be prompted to provide his/her opinion regarding whether said identifying is correct; and
reporting, by the one or more processors, information regarding the opinion to the online security service.

4. The method of claim 2, wherein each phishing fingerprint of the plurality of fingerprints contained within the phishing fingerprint database is a representative of a cluster of a plurality of fingerprints, thereby improving efficiency of transmission of the update from the online security service to the client device and performance of said comparing by the client device.

5. The method of claim 1, wherein said generating, by the one or more processors, a fingerprint comprises:
converting, by the one or more processors, the captured image to a grayscale image;
downsizing, by the one or more processors, the grayscale image to a thumbnail image of a pre-determined size;
determining, by the one or more processors, a row hash and a column hash for the thumbnail image; and
forming, by the one or more processors, the fingerprint by combining the row hash and the column hash.

6. The method of claim 5, wherein the similarity measure comprises a cumulative similarity index and wherein the cumulative similarity index is determined based on a number of corresponding bits that differ between the generated fingerprint and the phishing fingerprint.

7. The method of claim 6, wherein the cumulative similarity index is determined by performing an exclusive or (XOR) operation between the generated fingerprint and each of the plurality of fingerprints.

8. The method of claim 1, wherein the hash function comprises a perceptual hash function.

9. The method of claim 8, wherein the perceptual hash function comprises a difference hash (dHash).

10. The method of claim 9, wherein the generated fingerprint comprises a combination of a row hash and a column hash of a downsized grayscale version of the captured image.

11. The method of claim 10, wherein the generated fingerprint comprises 128 bits.

12. A method comprising:
maintaining, by a server of an online security service, a first database of a plurality of suspicious webpages that have been reported by one or more clients of subscribers of a plurality of subscribers to the online security service, including, for each suspicious webpage of the plurality of suspicious webpages, a suspicious fingerprint of the suspicious webpage generated based on application of a hash function to an image of the suspicious webpage, a first count of reports received by clients of the subscribers identifying the suspicious webpage as a phishing webpage, a second count of reports received by clients of the subscribers identifying the suspicious webpage as not being a phishing webpage, and a ratio of the first count or the second count to a sum of the first count and the second count;
maintaining, by the server, a second database of a plurality of confirmed phishing webpages, including, for each confirmed phishing webpage of the plurality of confirmed phishing webpages, a confirmed fingerprint of the confirmed phishing webpage generated based on application of the hash function to an image of the confirmed phishing webpage, an indication regarding a cluster of a plurality of clusters of fingerprints with which the confirmed fingerprint is associated, and an indication regarding whether the confirmed fingerprint is a representative of the cluster;
periodically updating, by the server, the plurality of clusters of fingerprints, by, for each suspicious webpage:
comparing the ratio for the suspicious webpage to a predetermined or configurable threshold; and
when said comparing is indicative of the suspicious webpage being a confirmed phishing webpage, then performing a clustering process to either add the suspicious fingerprint of the suspicious webpage to an existing cluster of the plurality of clusters of fingerprints or create a new cluster within the plurality of clusters of fingerprints for which the suspicious fingerprint will serve as a representative of the new cluster; and
facilitating, by the server, detection of phishing webpages by a plurality of client devices periodically delivering, by the server, updates to clients of the plurality of subscribers, including at least representative fingerprints of new clusters added to the plurality of clusters of fingerprints, if any, since a most recent update.

13. A non-transitory computer-readable storage medium embodying a set of instructions, which when executed by one or more processors of a client device, causes the one or more processors to perform a method of detecting phishing webpages, said method comprising:
capturing, by the one or more processors of the client device, an image pertaining to a webpage attempted to be accessed via the client device;
generating, by the one or more processors, a fingerprint of the webpage based on application of a hash function to the captured image;
for each phishing fingerprint within a phishing fingerprint database containing a plurality of fingerprints associated with one or more of a plurality of known phishing webpages:
determining, by the one or more processors, a similarity measure between the generated fingerprint and the phishing fingerprint by comparing the generated fingerprint with the phishing fingerprint; and
responsive to the similarity measure meeting a predefined or configurable threshold, identifying, by the one or more processors, the webpage as potentially being a phishing webpage.

14. The non-transitory computer-readable storage medium of claim 13, further comprising periodically receiving, by the one or more processors, an update to the phishing fingerprint database containing new fingerprints from an online security service.

15. The non-transitory computer-readable storage medium of claim 14, further comprising responsive to the similarity measure meeting the predefined or configurable threshold:
causing, by the one or more processors, an end user of the client device to be prompted to provide his/her opinion regarding whether said identifying is correct; and
reporting, by the one or more processors, information regarding the opinion to the online security service.

16. The non-transitory computer-readable storage medium of claim 14, wherein each phishing fingerprint of the plurality of fingerprints contained within the phishing fingerprint database is a representative of a cluster of a plurality of fingerprints, thereby improving efficiency of transmission of the update from the online security service to the client device and performance of said comparing by the client device.

17. The non-transitory computer-readable storage medium of claim 13, wherein said generating, by the one or more processors, a fingerprint comprises:
converting, by the one or more processors, the captured image to a grayscale image;
downsizing, by the one or more processors, the grayscale image to a thumbnail image of a pre-determined size;
determining, by the one or more processors, a row hash and a column hash for the thumbnail image; and
forming, by the one or more processors, the fingerprint by combining the row hash and the column hash.

18. The non-transitory computer-readable storage medium of claim 17, wherein the similarity measure comprises a cumulative similarity index and wherein the cumulative similarity index is determined based on a number of corresponding bits that differ between the generated fingerprint and the phishing fingerprint.

19. The non-transitory computer-readable storage medium of claim 18, wherein the cumulative similarity index is determined by performing an exclusive or (XOR) operation between the generated fingerprint and each of the plurality of fingerprints.

20. A non-transitory computer-readable storage medium embodying a set of instructions, which when executed by one or more processors of a server, causes the one or more processors to perform a method comprising:
maintaining, by the server of an online security service, a first database of a plurality of suspicious webpages that have been reported by one or more clients of subscribers of a plurality of subscribers to the online security service, including, for each suspicious webpage of the plurality of suspicious webpages, a suspicious fingerprint of the suspicious webpage generated based on application of a hash function to an image of the suspicious webpage, a first count of reports received by clients of the subscribers identifying the suspicious webpage as a phishing webpage, a second count of reports received by clients of the subscribers identifying the suspicious webpage as not being a phishing webpage, and a ratio of the first count or the second count to a sum of the first count and the second count;
maintaining, by the server, a second database of a plurality of confirmed phishing webpages, including, for each confirmed phishing webpage of the plurality of confirmed phishing webpages, a confirmed fingerprint of the confirmed phishing webpage generated based on application of the hash function to an image of the confirmed phishing webpage, an indication regarding a cluster of a plurality of clusters of fingerprints with which the confirmed fingerprint is associated, and an indication regarding whether the confirmed fingerprint is a representative of the cluster;
periodically updating, by the server, the plurality of clusters of fingerprints, by, for each suspicious webpage:
comparing the ratio for the suspicious webpage to a predetermined or configurable threshold; and
when said comparing is indicative of the suspicious webpage being a confirmed phishing webpage, then performing a clustering process to either add the suspicious fingerprint of the suspicious webpage to an existing cluster of the plurality of clusters of fingerprints or create a new cluster within the plurality of clusters of fingerprints for which the suspicious fingerprint will serve as a representative of the new cluster; and
facilitating, by the server, detection of phishing webpages by a plurality of client devices periodically delivering, by the server, updates to clients of the plurality of subscribers, including at least representative fingerprints of new clusters added to the plurality of clusters of fingerprints, if any, since a most recent update.
